(19) United States
(12) Patent Application Publication
(10) Pub. No.: US 2023/0287215 A1
(43) Pub. Date: Sep. 14, 2023

(54) NON-ASPHALT BASED SEALANT WITH HIGH ADHESION

(71) Applicant: Adventus Material Strategies, LLC, Daniel Island, SC (US)

(72) Inventors: Joseph Drbohlav, III, Inman, SC (US); Joseph J. Lorenc, Philadelphia, PA (US); Brian J. Majeska, Mount pleasant, SC (US)

(21) Appl. No.: 18/118,293

(22) Filed: Mar. 7, 2023

Related U.S. Application Data
(60) Provisional application No. 63/318,452, filed on Mar. 10, 2022.

(51) Int. Cl. C08L 93/04

(52) U.S. Cl. CPC C08L 93/04; C08L 2203/162; C08L 2205/03; C08L 2207/04

(57) ABSTRACT

A non-asphaltic sealant composition, and methods of producing and using the sealant composition, wherein the non-asphaltic sealant composition includes a sufficient amount of one or more polar, non-asphaltic base resins having functional groups for hydrogen bonding to provide high adhesion for sealing cracks and joints in polar concrete pavements and other polar substrates.

### RELATED CASE

This application claims the benefit of U.S. Provisional Patent Application Ser. No. 63/318,452 filed on Mar. 10, 2022 and incorporates said provisional application by reference into this document as if fully set out at this point.

### FIELD OF THE INVENTION

The present invention relates to non-asphalt based sealant compositions for sealing cracks and joints in roads, streets, highways, sidewalks, pavements, and other concrete and asphalt surfaces.

### BACKGROUND OF THE INVENTION

Asphalt is commonly used as a base material for producing hot-applied crack and joint sealants for roads, pavements, and other asphalt and concrete surfaces. Asphalt-based sealants are relatively inexpensive, are water-resistant, provide acceptable thermal performance over a range of temperature conditions, and can be modified by adding polymers to provide enhanced mechanical properties.

Unfortunately, the pigmented and non-pigmented colors of asphalt-based sealants are generally limited to black or brown. However, advancements have been made in the development of hot-applied non-asphaltic sealant products which can be pigmented to virtually any color, including even the gray color of Portland cement concrete.

Hot-applied crack and joint sealants must meet several performance parameters in order to render them useful for effective waterproofing of cracks and joints in asphalt and concrete pavements. One parameter that is critically important to performance is the bond strength or adhesive strength formed between the sealant and the pavement.

Adhesion or bond strength can be measured qualitatively by applying a sealant material to a substrate and then judging the degree of effort or force required to “peel” or de-bond the sealant from the substrate. Alternatively, other methods that are more quantitative in nature can be used to measure the strength of adhesion between a crack and joint sealant and the substrate to which it is applied. Examples of two such tests are the peel test set forth in ASTM C794 and the tensile adhesion test described in ASTM D5329. In the ASTM C794 peel test, the pulling force in pounds per linear inch required to peel the applied sealant from the substrate is measured. In the tensile adhesion test of ASTM D5329, two concrete blocks having the sealant applied therebetween are pulled apart at a uniform rate and the distance which the sealant stretches before it breaks or de-bonds from the concrete substrates is measured.

Unfortunately, the bonding and adhesion characteristics of the non-asphaltic sealant products heretofore available in the market have been poor or inadequate. Even the best of these prior non-asphaltic sealant compositions can typically be peeled-off of a concrete substrate fairly easily by hand.

Consequently, a need exists for a non-asphalt-based crack and joint sealant composition with significantly improved adhesion and bonding properties. Moreover, a need particularly exists for a non-asphaltic sealant composition which provides improved adhesion and bonding strength and is also fully pigmentable.

### SUMMARY OF THE INVENTION

The present invention provides a non-asphaltic sealant composition, and methods of production and use, which provide excellent adhesion and bonding strength on concrete and other substrates.

We have discovered that a key factor in the adhesion or bonding strength of a crack or joint sealant to concrete pavements has to do with the composition of the non-asphaltic base resin which is used in forming the sealant. The use of non-asphaltic resinous components that bear chemical functionality that is polar in nature, and which preferably have chemical functionality for hydrogen bonding, results in superior adhesion of the sealant to a concrete substrate. Without being bound to any theory, we believe that because of the polar nature of concrete surfaces, which is primarily due to the hydroxyl functionality of concrete, a much superior bond is formed by using the inventive sealants compositions disclosed herein which comprise resinous base components having chemical functionality for hydrogen bonding. Such chemical functionality includes, but is not limited to, hydroxyl, carboxylic acid, ester, and amine functional groups.

To improve or maximize the adhesive strength between the sealant and a concrete substrate, the total amount of the one or more polar, non-asphaltic resinous components used in the sealant composition will preferably be at least 1% by weight based upon the final weight of the sealant composition (i.e., the weight of the composition after all components have been added). The total amount of the one or more polar, non-asphaltic resinous components will more preferably be at least 10% by weight and will most preferably be at least 30% by weight, based upon the total final weight of the sealant composition.

By way of example, in one aspect, there is provided a non-asphalt-based sealant composition having high adhesion for sealing cracks and joints in polar concrete pavements and other polar substrates wherein the non-asphalt-based sealant composition preferably comprises a polar non-asphaltic sealant base blend which includes (a) one or more polar non-asphaltic base resins having functional groups for hydrogen bonding, (b) one or more processing oils, and (c) one or more plasticizing materials. The non-asphalt-based sealant composition also preferably comprises one or more elastomeric polymer materials. The one or more polar non-asphaltic base resins used in the polar non-asphaltic sealant base blend are preferably present in the polar non-asphaltic sealant base blend in a total amount which both (i) is equivalent to an amount of at least 30% by weight of a total final weight of the non-asphalt-based sealant composition and (ii) causes the non-asphalt-based sealant composition to undergo hydrogen bonding when applied to polar substrates.

Further aspects, features, and advantages of the present invention will be apparent to those skilled in the art upon reading the following detailed description of the preferred embodiments.

### DETAILED DESCRIPTION OF THE PREFERRED EMBODIMENTS

The non-asphaltic sealant composition provided by the present invention is preferably formed using a non-asphaltic sealant base blend which comprises: (i) at least one processing oil, (ii) at least one epoxidized ester of a vegetable oil and/or at least one other plasticizing material, and (iii) one or more polar, non-asphaltic resinous base materials. To improve or maximize the adhesive bonding strength between the inventive non-asphaltic sealant composition and a concrete or other substrate, the total amount of the one or more polar, non-asphaltic resinous components used in the base blend will preferably be an amount which will be equivalent to at least 1% by weight of the total final weight of the sealant composition after all components have been added. The total amount of the one or more polar, non-asphaltic resinous components used in the base blend will more preferably be an amount which is equivalent to at least 10% by weight, or at least 15% by weight, or at least 20% by weight, or at least 25% by weight, or at least 30% by weight, or at least 35% by weight, or at least 40% by weight, of the total final weight of the sealant composition.

We have discovered that one group of resinous base materials that bear or can bear functional groups that are highly polar in nature and capable of forming hydrogen bonds, and which provide high adhesion and bonding strength for concrete substrates or substrates formed of portland cement or mortars containing portland cement or similar minerals, are rosin esters. Rosin esters commonly comprise amorphous, esterified mixtures of low molecular weight resins produced from the pulping or processing of wood. Free carboxylic acid groups present in the rosin material are esterified using hydroxyl-containing compounds. The esterified rosin material bears chemical functionality that is polar in nature and can undergo hydrogen bonding interactions with substrates, such as concrete pavements, that are also polar in nature.

The rosin ester material used in the inventive sealant composition can comprise a single rosin ester or a combination of two or more rosin esters. Rosin ester materials will typically have softening points of greater than 50° C. and needle penetration values of near 0 dmm at 25° C. The rosin ester material used in the inventive sealant composition will preferably have (a) a softening point in the range of from about 80° C. to about 120° C., more preferably from about 95° C. to about 110° C., and (b) an acid number of less than 20 mg/g and more preferably less than 15 mg/g.

To facilitate the pigmenting processes, the rosin ester material will preferably be relatively translucent or have a lighter color. For pigmenting purposes, the Gardner Color of the rosin ester material will preferably be less than 10.0 and will more preferably be less than 7.0.

Examples of rosin ester materials suitable for use in the inventive non-asphaltic sealant composition include, but are not limited to, pine-based pentaerythritol ester resins, pine-based glycerol ester resins, and pine-based ester resins esterified using other readily available glycols bearing hydroxyl functionality.

The rosin ester material will preferably be or comprise a pine-based pentaerythritol ester resin. An example of a commercially available pine-based pentaerythritol ester resin is WESTREZ Rosin Ester 5101 produced by Ingevity of Charleston, S.C.

In addition or as an alternative to such rosin ester materials, examples of other types of polar, non-asphalt sealant base resins suitable for use in the base blend of the inventive non-asphaltic sealant composition include, but are not limited to: polyurethane resins such as those derived from the reaction of one or more isocyanate compounds with a flexible chain extender, preferentially a polyether-ester or polyether-amide; epoxy resins such as epoxy resins based on the diglycidyl ether of Bisphenol-A (DGEBA) and DGEBA that is modified with flexible diamines or flexible diols to improve impact toughness; and silane-based resins that contain silanol functionality, such as polysiloxanes that are commercially available and used in the production of silicone elastomers.

The processing oil used in forming the non-asphaltic sealant base blend of the inventive composition will preferably comprise one or more aromatic, naphthenic, paraffinic, and/or vegetable oils. The processing oil will preferably (a) be relatively translucent or have a lighter color, which further facilitates the pigmenting process, (b) be effective for blending with the rosin ester material to produce a softening point of the base blend in the range of from about 40° to about 70° C. and a needle penetration value of the base blend in the range of from about 20 to about 80 dmm at 25° C., and (c) have an aromatic content of at least 40% by weight, or at least 45%, 50%, 55%, 60%, 65% or 70% by weight, based upon the total weight of the processing oil.

Examples of commercially available processing oils which are well suited for blending with pine-based pentaerythritol resins and other rosin materials are SUNDEX 165 (an aromatic processing oil having a molecular weight of 588 and an aromatic content of 55% by weight based upon the total weight of the SUNDEX 165) and HYDROLENE LPH. SUNDEX 165 and HYDROLENE LPH are available from HollyFrontier Lubricants and Specialty Products of Tulsa, Okla.

The one or more plasticizing materials used in forming the sealant base blend for the inventive non-asphaltic sealant composition will preferably comprise one or more epoxidized esters of vegetable oils and will also preferably be relatively translucent or have a lighter color. Examples of epoxidized esters of vegetable oils suitable for use in forming the sealant base blend used in the inventive composition include, but are not limited to, epoxidized esters of soybean oil, corn oil, tall oil, and sunflower oil. The epoxidized ester of vegetable oil will preferably be an epoxidized ester of soybean oil and will most preferably be an epoxy functionalized methyl ester of soybean oil. Examples of other epoxidized esters of soybean oil suitable for use in the present invention include, but are not limited to, benzyl, propyl, and ethyl esters of soybean oil.

Examples of other types of plasticizers suitable for use in the base blend of the inventive non-asphaltic sealant composition include, but are not limited to, esters derived from vegetable oil fatty acids, esters and diesters derived from the esterification of fatty alcohols and carboxylic acids, or from the esterification of alcohols with fatty acids, hydrogenated and non-hydrogenated aromatic oils and related petroleum distillates, hydrogenated and non-hydrogenated naphthenic oils and related petroleum distillates, and paraffinic oils and distillates.

In addition to the non-asphaltic base blend, the non-asphaltic sealant composition of the present invention will also preferably include one or more elastomeric polymer materials which modify the pigmented base blend to provide enhanced mechanical properties. Examples of elastomeric polymer materials suitable for use in the inventive non-asphaltic sealant composition include, but are not limited to: styrene block polymers such as radial and/or linear styrene butadiene styrene (SBS) block copolymers, styrene butadiene copolymers, styrene isoprene copolymers, and styrene isoprene styrene (SIS) block copolymers; ethylene vinyl acetate (EVA); polymers such as ethylene-propylene-diene monomer rubber (EPDM) formed by the copolymerization of ethylene and propylene with suitable monomers to disrupt crystallinity; acrylic copolymers and terpolymers such as butyl acrylate and glycidyl methacrylate, which are derived from copolymerization of ethylene with acrylic monomers; and combinations thereof. The one or more elastomeric polymer materials will preferably comprise an SBS polymer and/or an SIS polymer and will more preferably comprise a radial SBS polymer.

Commercially available sealants typically also include mineral or other inorganic fillers which reduce the cost and/or improve one or more of the high temperature performance characteristics of the sealant composition. Examples of inorganic filler materials suitable for use in the inventive non-asphaltic sealant composition include, but are not limited to, titanium dioxide, ferric oxide, talc, calcium carbonate, fly ash, silica, alumina-based inorganic materials, and combinations thereof. If present, the amount of inorganic filler used in the inventive non-asphaltic sealant composition will typically be at least 2% or at least 3% or at least 4% or at least 5% or at least 6% by weight of the total final weight of the non-asphaltic composition and will more typically be in the range of from 6.5% to 24% by weight of the total final weight of the non-asphaltic sealant composition.

For pigmentation purposes, the inventive non-asphaltic sealant composition can also comprise (a) one or more color-neutralizing materials (one of said one or more materials preferably being titanium dioxide) which assist(s) in significantly or entirely neutralizing a non-white shade or color of the sealant base blend and (b) one or more pigment materials which impart a desired end color to the color-neutralized sealant base blend.

Although other procedures can be used and the order or manner of adding the individual components can be changed, the inventive non-asphaltic sealant composition will preferably be prepared by first combining the components of the sealant base blend. The sealant base blend of the inventive non-asphaltic sealant composition is preferably prepared by: (i) heating the processing oil to a blending temperature in the range of from about 300° F. to about 350° F. (more preferably from about 320° to about 330° F.) while applying low shear agitation or mixing; (ii) adding the one or more plasticizers to the heated processing oil with low shear agitation or mixing and with continued heating as required to maintain the blending temperature; (iii) then adding the rosin ester material and/or other polar non-asphaltic resin material with continued low shear agitation or mixing and with continued heating to maintain the blending temperature; and then (iv) continuing to agitate or mix the resulting blend at the blending temperature until the rosin ester and/or other polar resin material is/are melted and fully incorporated in the processing oil.

The total amount of the rosin ester material and/or other polar resin material added to the sealant base blend will preferably be at least 30% by weight or will be at least 35% or at least 40% or at least 41% or at least 42% or at least 43% or at least 44% or at least 45% by weight, based upon the total final weight of the sealant composition. The total amount of the rosin ester material and/or other polar resin material added to the sealant base blend will preferably be in the range of from 35% to 65% by weight based upon the total final weight of the non-asphaltic sealant composition.

The amount of the processing oil used in forming the sealant base blend will preferably be in the range of from about 5% to about 30% by weight, more preferably in the range of from about 8% to about 25% by weight, based upon the total final weight of the inventive non-asphaltic sealant composition.

The total amount of the one or more plasticizing materials used in forming the sealant base blend will preferably be in the range of from about 0.5% to about 6% by weight, more preferably in the range of from about 1% to about 4% by weight, based upon the total final weight of the inventive non-asphaltic sealant composition.

Because of the materials used in forming the inventive polar sealant base blend, the sealant base blend will have a non-white shade or color which will typically range from light yellow to light or medium brown. For pigmentation purposes, the non-white shade or color of the sealant base blend can be at least partially neutralized, more preferably substantially or entirely neutralized, prior to pigmenting the inventive composition to its desired final color. The non-white shade or color of the sealant base blend will preferably be significantly or entirely neutralized by: (1) maintaining the blending temperature of the sealant base blend while adding titanium dioxide thereto with mixing and (2) continuing to maintain the blending temperature of the sealant base blend while adding any additional color-neutralizing materials thereto with mixing. Although high shear and/or high-speed mixing may be needed in some circumstances, maintaining the temperature of the base blend in the range of from 300° F. to 350° F. will typically allow low speed and/or low shear mixing to be used for incorporating and dispersing the TiO₂ and any additional color-neutralizing materials.

When needed for incorporating the titanium dioxide and/or other color-neutralizing materials, high shear mixing can more effectively overcome the forces of attraction between adjacent TiO₂ or other particles, thereby more readily breaking up and dispersing TiO₂ or other agglomerates into separate particles.

As used herein, the term “high-speed and/or high shear” mean the use of mixing equipment that provides a high rate of rotation of typically in excess of 1000 rotations per minute (rpm) and more typically in excess of 2000 rpm. The high shear mixing also forces the material through a small or narrow gap, thus imparting relatively high levels of shear stress to the material and helping to break apart and disperse agglomerations.

Examples of devices and systems suitable for high speed and/or high shear mixing of the inventive composition include, but are not limited to, Silverson® laboratory mixers with high shear milling heads, rotor-stator mills, and Cowles mixers.

As used herein, the term “low speed and/or low shear” means a speed of less than 1000 rpm, more preferably less than 750 rpm, and more preferably 500 rpm or less. Examples of suitable low speed mixing devices or systems include, but are not limited to, low speed paddle mixers or agitators.

The titanium dioxide used in the inventive sealant composition and method for pigmentation purposes acts as a whitener for neutralizing the yellow or brownish color of the sealant base blend and also serves as a filler. The TiO₂ can be in any crystalline form, including rutile or anatase titanium dioxide, and will preferably be rutile titanium dioxide. The amount of titanium dioxide added to the sealant base blend in the color-neutralization step of the inventive method will preferably be in the range of from about 3% to about 20% by weight, more preferably from about 5% to about 15% by weight, based upon the total final weight of the inventive pigmented sealant composition after the titanium dioxide, any additional color-neutralizing materials, the one or more pigment materials, and the one or more elastomeric polymer materials, as well as any other inorganic filler, have been added to the sealant base blend.

Examples of additional color-neutralizing materials which can be added to the sealant base blend in the color-neutralizing step of the inventive method can include, but are not limited to, calcium carbonate, blue pigments, and combinations thereof.

When used as an additional color neutralizing agent, calcium carbonate will preferably be added to the sealant base blend in an amount in the range of from about 1% to about 20% by weight, more preferably from about 3% to 15% by weight, based upon the total final weight of the inventive pigmented sealant composition.

In many cases, even after the addition of titanium dioxide and calcium carbonate to the sealant base blend, a slight yellow color will remain. As an additional color neutralizing agent for neutralizing the remaining the yellow color, a blue pigment can also be added to the sealant base blend in an amount in the range of from about 0.1% to about 5% by weight, more preferably from about 0.5% to about 2% by weight, based upon the total final weight of the inventive pigmented, non-asphaltic sealant composition.

The at least partially color-neutralized sealant base blend can be pigmented to achieve generally any non-white shade or color desired for the final pigmented composition. In accordance with the inventive method, the at least partially color-neutralized sealant base blend will preferably be pigmented by (1) continuing to maintain the neutralized sealant base blend at the blending temperature while (2) adding one or more pigment materials to the neutralized sealant base blend with mixing. Although high shear and/or high-speed mixing may be needed in some circumstances, maintaining the temperature of the color-neutralized base blend in the range of from 300° F. to 350° F. will typically allow low speed and/or low shear mixing to be used for incorporating and dispersing the one or more pigment materials.

The one or more pigment materials can be generally any heat-stable pigment(s). Examples of pigment materials suitable for use in the inventive composition to achieve desired end colors include, but are not limited to, gray pigments such as Gilsonite and red pigments such as iron oxides and hydrates of iron oxide salts.

The one or more pigment materials can be added to the at least partially neutralized sealant base blend as needed to achieve the desired end color. The one or more pigment materials will typically be added in an amount in the range of from 0.1% to about 6% by weight, more typically from about 0.3% to about 4% by weight, based upon the total final weight of the inventive pigmented sealant composition after the titanium dioxide, any additional color-neutralizing materials, the one or more pigment materials, and the one or more elastomeric polymer materials have been added to the sealant base blend.

As will be understood by those skilled in the art, pigments sometimes include carrier materials. Consequently, as used herein and in the claims, a weight amount or percentage amount or concentration stated for any color-neutralizing material or pigment material used in the inventive composition includes any carrier material which is contained in the color-neutralizing or pigment material.

The use of Gilsonite powder in the pigmenting step has shown to be particularly effective in achieving a gray tone similar or identical to Portland cement concrete.

If the inventive non-asphaltic sealant composition is pigmented, the one or more elastomeric polymer materials used in the inventive composition will preferably be added after the pigmenting steps.

In accordance with the inventive method, the one or more elastomeric polymer materials are preferably added to the pigmented sealant base blend by (1) increasing the temperature of the pigmented sealant base blend to a temperature in the range of from about 350° F. to about 385° F., (2) adding the one or more elastomeric polymer materials, preferably with low shear agitation or mixing, while maintaining a temperature of from about 350° F. to about 385° F., and (3) continuing the low shear agitation or mixing at a temperature of from about 350° F. to about 385° F. until complete dissolution of the polymer material(s) is achieved (typically at least 6 hours). The one or more elastomeric polymer materials will preferably be added to the pigmented sealant base blend in an amount in the range of from about 2% to about 20% by weight, more preferably from about 3% to about 15% by weight, based upon the total weight of the final non-asphaltic sealant product composition.

Once prepared, the hot, non-asphaltic sealant composition provided by the present invention can be applied to a concrete or other substrate surface to seal cracks and joints using generally any of the procedures and equipment used for applying asphalt-based sealants.

The following examples are provided solely for the purpose of illustration, not limitation.

### EXAMPLE 1

This example provided an inventive, hot-applied, non-asphalt-based, pigmented sealant product composition which was prepared in accordance with the present invention. Unless otherwise indicated, all percentages stated in this example are percentages by weight based upon the total final weight of the pigmented sealant product composition.

A non-asphalt base blend was formed by combining 43.9% of a polar rosin ester material (Westrez Rosin Ester 5101 which is a pine-based pentaerythritol ester resin produced by Ingevity of Charleston, S.C.) with 23% of Sundex 165 (an aromatic processing oil having a molecular weight of 588 and an aromatic content of 55% by weight based upon the total weight of the Sundex 165) and 2% of EMS-100 (an epoxidized methyl ester of soybean oil manufactured by ACS of Indiana).

The non-asphalt base blend was heated to 325° F. and fully homogenized, using a low-speed paddle blender at 450 RPM, for a period suitable to fully melt and incorporate the rosin ester particles into the processing oil. The polar, non-asphalt base blend had a softening point of 50° C. and a needle penetration of 35 dmm at 25° C. and was therefore comparable to an AC-20 or AC-30 base asphalt.

Next, 10.5% of TiO₂ (PL-4950 manufactured by PL Industries) was added to the 325° F. base blend, with low shear mixing at 450 RPM, as a color-neutralizing material to whiten the base blend. After the addition and incorporation of the TiO₂, the base blend still had a slight yellow color. Consequently, 8.8% of calcium carbonate (HuberCarb M4) and 0.9% of an Ultramarine Blue pigment (ME-2387 available from PL Industries) were added and incorporated into the blend at 325° F. with continued low shear mixing to fully neutralize the slight yellow color.

After the color of the base blend was neutralized, the color-neutralized base blend was pigmented by adding 0.9% of Gilsonite HMA powder at 325° F. with low shear mixing at 450 RPM to give the base composition a gray color resembling the color of Portland cement concrete.

Next, 10% of a high molecular weight SBS polymer with a radial architecture (Dynasol Solprene 411) was added to the pigmented base blend at 370° F. with low shear mixing at 450 RPM. The mixing was continued for six hours until the SBS polymer was fully incorporated.

The inventive pigmented sealant product had: (1) a Ring and Ball Softening Point of 84° C.; (2) a Cone Penetration of 52 dmm at 25° C.; (3) a Resilience of 80% at 25° C.; and (4) a Ductility (ASTM D113) of 36.5 cm at 4° C.

The inventive non-asphaltic sealant composition using the polar rosin ester base material demonstrated extremely strong bonding to concrete substrates. After cooling, the inventive hot-applied sealant material could not be peeled off of or pulled off of a concrete surface by hand. The inventive non-asphaltic sealant composition demonstrated an ASTM C794 (Peel Test) average maximum load of 88.87 lbs force. In an ASTM D5329 tensile adhesion test, the inventive non-asphaltic sealant composition had an average elongation at failure of 644%.

### EXAMPLE 2

For comparison purposes, Deery Super Gray Joint Sealant, a commercially available pigmented, hot-applied, non-asphaltic sealant composition available from Crafco Inc. was subjected to the same tests and procedures as the inventive hot-applied, non-asphaltic sealant composition produced in Example 1. The Deery sealant product was formed using a non-polar base resin material.

The Deery Super Gray sealant product demonstrated: (1) a Ring and Ball Softening Point of 97° C.; (2) a Cone Penetration of 46 dmm at 25° C.; (3) a Resilience of 86% at 25° C.; and (4) a Ductility (ASTM D113) of 35.5 cm at 4° C.

The bonding and adhesion properties demonstrated by the Deery product were inferior to those of the inventive non-asphaltic sealant composition of Example 1. After cooling, the Deery sealant material was easily peeled off of a concrete surface, by hand, with relatively little force or effort. The Deery sealant composition demonstrated an ASTM C794 (Peel Test) average maximum load of just 40.60 lbs force. In an ASTM tensile adhesion test, the Deery sealant composition had an average elongation at failure of only 275%.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within this invention as called for in the claims.

What is claimed is:

1. A non-asphalt-based sealant composition having high adhesion for sealing cracks and joints in polar concrete pavements and other polar substrates, the non-asphalt-based sealant composition comprising:
A polar non-asphaltic sealant base blend comprising
one or more polar non-asphaltic base resins having functional groups for hydrogen bonding,
one or more processing oils,
one or more plasticizing materials, and
the one or more polar non-asphaltic base resins being present in the polar non-asphaltic sealant base blend in a total amount which both (i) is equivalent to an amount of at least 30% by weight of a total final weight of the non-asphalt-based sealant composition and (ii) causes the non-asphalt-based sealant composition to undergo hydrogen bonding when applied to polar substrates and
one or more elastomeric polymer materials.

2. The non-asphalt-based sealant composition of claim 1 further comprising the functional groups for hydrogen bonding of the one or more polar non-asphaltic base resins being ester functional groups, hydroxyl functional groups, carboxylic acid functional groups, and/or amine functional groups.

3. The non-asphalt-based sealant composition of claim 1 further comprising the total amount of the one or more polar non-asphaltic base resins in the polar non-asphaltic sealant base blend being an amount equivalent to an amount of from 35% to 65% by weight based upon the total final weight of the non-asphalt-based sealant composition.

4. The non-asphalt-based sealant composition of claim 1 further comprising the one or more polar non-asphaltic base resins comprising one or more polar rosin esters.

5. The non-asphalt-based sealant composition of claim 4 further comprising the one or more polar rosin esters being (i) one or more pine-based pentaerythritol ester resins, (ii) one or more pine-based glycerol ester resins, and/or (iii) one or more other pine-based ester resins esterified using glycols bearing hydroxyl functionality.

6. The non-asphalt-based sealant composition of claim 4 further comprising the one or more polar rosin esters being one or more pine-based pentaerythritol ester resins.

7. The non-asphalt-based sealant composition of claim 1 further comprising the one or more polar non-asphaltic base resins comprising (i) one or more polyurethane resins derived from a reaction of one or more isocyanate compounds with a flexible chain extender; (ii) one or more epoxy resins based on a diglycidyl ether of Bisphenol-A (DGEBA); (iii) one or more polyurethane resins derived from DGEBA that is modified with flexible diamines or flexible diols; and/or (iv) one or more silane-based resins having silanol functionality.

8. The non-asphalt-based sealant composition of claim 1 further comprising:
the one or more processing oils being present in the polar non-asphaltic sealant base blend in a total amount which is equivalent to an amount of from 35% to 65% by weight based upon the total final weight of the non-asphalt-based sealant composition and
the one or more plasticizing materials being present in the polar non-asphaltic sealant base blend in a total amount which is equivalent to an amount of from 0.5% to 6% by weight based upon the total final weight of the non-asphalt-based sealant composition.

9. The non-asphalt-based sealant composition of claim 8 further comprising the one or more processing oils comprising one or more aromatic, naphthenic, paraffinic, and/or vegetable oils, the one or more processing oils having a total aromatic content of at least 40% by weight based on a total weight of the one or more processing oils.

10. The non-asphalt-based sealant composition of claim 8 further comprising the one or more plasticizing materials comprising one or more epoxidized esters of one or more vegetable oils.

11. The non-asphalt-based sealant composition of claim 8 further comprising the one or more plasticizing materials comprising an epoxy functionalized methyl ester of soybean oil.

12. The non-asphalt-based sealant composition of claim 8 further comprising the one or more plasticizing materials being selected from: esters derived from vegetable oil fatty acids; esters and diesters derived from esterification of fatty alcohols and carboxylic acids, or from esterification of alcohols with fatty acids; hydrogenated and non-hydrogenated aromatic oils and distillates; hydrogenated and non-hydrogenated naphthenic oils and distillates; and paraffinic oils and distillates.

13. The non-asphalt-based sealant composition of claim 1 further comprising the one or more elastomeric polymer materials being present in the non-asphalt-based sealant composition in a total amount of from 2% to 20% by weight based upon the total final weight of the non-asphalt-based sealant composition.

14. The non-asphalt-based sealant composition of claim 13 further comprising the one elastomeric polymer materials being selected from: radial and/or linear styrene butadiene styrene (SBS) block copolymers; styrene butadiene copolymers; styrene isoprene copolymers; styrene isoprene styrene (SIS) block copolymers; ethylene vinyl acetate (EVA); ethylene-propylene-diene monomer rubber (EPDM) formed by copolymerization of ethylene and propylene with monomers which disrupt crystallinity; butyl acrylate; glycidyl methacrylate; other polymers derived from copolymerization of ethylene with acrylic monomers; and combinations thereof.

15. The non-asphalt-based sealant composition of claim 13 further comprising the one elastomeric polymer materials being a SBS polymer and/or a SIS polymer.

16. The non-asphalt-based sealant composition of claim 1 further comprising one or more color-neutralizing materials which at least partially neutralize a non-white shade or color of the polar non-asphaltic sealant base blend, the one or more color-neutralizing materials comprising titanium dioxide in an amount which is from 3% to 20% by weight based upon the total final weight of the non-asphalt-based sealant composition.

17. The non-asphalt-based sealant composition of claim 1 further comprising one or more pigment materials which impart a desired end color to the polar non-asphaltic sealant base blend in a total amount of from 0.1% to about 6% by weight based upon the total final weight of the non-asphalt-based sealant composition.

18. The non-asphalt-based sealant composition of claim 17 further comprising the one or more pigment materials comprising Gilsonite powder.

19. The non-asphalt-based sealant composition of claim 1 further comprising one or more inorganic filler materials in a total amount of from 6.5% to 24% by weight based upon the total final weight of the non-asphalt-based sealant composition.
